(19) United States
(12) Patent Application Publication
(10) Pub. No.: US 2025/0346744 A1
(43) Pub. Date: Nov. 13, 2025

(54) METHOD FOR PREPARING A DIENE RUBBER COMPOSITION

(71) Applicant: Compagnie Generale Des Etablissements Michelin, Clermont-Ferrand (FR)

(72) Inventors: François JEAN-BAPTISTE-DIT-DOMINIQUE, Clermont-Ferrand (FR); Kahina MAMMERI, Clermont-Ferrand (FR)

(73) Assignee: Compagnie Generale Des Etablissements Michelin, Clermont-Ferrand (FR)

(21) Appl. No.: 18/870,060

(22) PCT Filed: May 4, 2023
(86) PCT No.: PCT/EP2023/061796

§ 371 Date: Nov. 27, 2024

(30) Foreign Application Priority Data
May 31, 2022 (FR) FR2205203

(51) Int. Cl. C08L 15/00; B60C 1/00; B60C 11/00; C08J 3/20; C08J 3/24; C08L 7/00

(52) U.S. Cl. CPC C08L 15/00; B60C 1/0016; B60C 11/0008; C08J 3/203; C08J 3/247; C08L 7/00; B60C 2011/0025; C08J 2307/00; C08J 2315/00; C08J 2409/06; C08J 2415/00

(57) ABSTRACT

The invention relates to a process for preparing a rubber composition which comprises an elastomer matrix which includes natural rubber and a synthetic diene elastomer, a modifying agent comprising a nitrile oxide dipole and an N-substituted imidazole function, a reinforcing filler comprising more than 50% by mass of a silica, a silane coupling agent and a vulcanization system, which process comprises prior kneading of the elastomer matrix alone before proceeding with the “non-productive” and “productive” kneading steps. The process enables a good compromise between the properties of hysteresis and stiffness and the amount of modifying agent.

### CROSS REFERENCE TO RELATED APPLICATIONS

This U.S. patent application is a national phase entry of PCT Patent Application No. PCT/EP2023/061796, filed May 4, 2023, which claims priority to French Patent Application No. FR2205203, filed May 31, 2022, the entire contents of which are incorporated herein by reference in their entirety.

### BACKGROUND

### 1. Technical Field

The field of the present invention is that of processes for preparing diene rubber compositions that are reinforced with a silica and are intended to be used in a tire tread.

### 2. Related Art

Ideally, a tread should offer a tire a very good level of road behaviour on a motor vehicle. This level of road behaviour can be contributed by the use, in the tread, of a rubber composition carefully chosen due to its rather high stiffness in the cured state. In order to increase the stiffness in the cured state of a rubber composition, it is known, for example, to increase the content of filler or to reduce the content of plasticizer in the rubber composition or also to introduce styrene and butadiene copolymers having a high styrene content into the rubber composition. However, some of these solutions generally have the disadvantage of increasing the hysteresis of the rubber composition.

In document WO2015059274, the Applicant has described that the introduction of a 1,3-dipolar compound containing a nitrile oxide dipole and an N-substituted imidazole function into silica-reinforced diene rubber compositions makes it possible to significantly reduce their hysteresis without reducing their stiffness in the cured state.

Seeking to further increase the stiffness of these rubber compositions, the Applicant has discovered a novel process for preparing a rubber composition which achieves this aim without degrading the hysteresis property of these compositions.

One subject of the invention is thus a process for preparing a rubber composition which comprises an elastomer matrix, a modifying agent comprising a nitrile oxide dipole and an N-substituted imidazole function, a reinforcing filler comprising more than 50% by mass of a silica, a silane coupling agent and a vulcanization system, which process comprises the following successive steps a, b, c and d:
a) incorporating, into the elastomer matrix, during a “non-productive” step, the modifying agent, the reinforcing filler and the silane coupling agent, by kneading until a maximum temperature of between 110° C. and 190° C. is reached,
b) cooling the combined mixture to a temperature of less than 100° C.,
c) subsequently incorporating the vulcanization system,
d) kneading everything up to a maximum temperature of less than 120° C., characterized in that the elastomer matrix comprises natural rubber and a synthetic diene elastomer, and in that the process comprises a step of thermomechanically kneading the elastomer matrix alone prior to step a).

### DETAILED DESCRIPTION OF EXAMPLE EMBODIMENTS

Any interval of values denoted by the expression “between a and b” represents the range of values greater than “a” and less than “b” (that is to say, limits a and b excluded), whereas any interval of values denoted by the expression “from a to b” means the range of values extending from “a” up to “b” (that is to say, including the strict limits a and b).

The compounds mentioned in the description may be of fossil origin or may be biobased. In the latter case, they may be partially or totally derived from biomass or obtained from renewable starting materials derived from biomass. In the same way, the compounds mentioned may also originate from the recycling of pre-used materials, that is to say that they may, partially or completely, result from a recycling process, or else be obtained from starting materials which themselves result from a recycling process.

In the present invention, the term “tire” is understood to mean a pneumatic or non-pneumatic tire. A pneumatic tire usually comprises two beads intended to come into contact with a rim, a crown composed of at least one crown reinforcement and a tread, two sidewalls, the tire being reinforced by a carcass reinforcement anchored in the two beads. A non-pneumatic tire, for its part, usually comprises a base, designed for example for mounting on a rigid rim, a crown reinforcement, ensuring the connection with a tread, and a deformable structure, such as spokes, ribs or cells, this structure being arranged between the base and the crown. Such non-pneumatic tires do not necessarily comprise a sidewall. Non-pneumatic tires are described, for example, in the documents WO 03/018332 and FR 2 898 077. According to any one of the embodiments of the invention, the tire according to the invention is preferentially a pneumatic tire.

In the present invention, “elastomer matrix” is understood to mean all of the elastomers of the rubber composition.

The abbreviation “phr” means parts by weight per hundred parts of the elastomer matrix.

A synthetic “diene” elastomer (or, without distinction, rubber) should be understood, in a known way, as meaning an elastomer which is not natural rubber and which is composed, at least in part (i.e., a homopolymer or a copolymer), of diene monomer units (monomers bearing two conjugated or non-conjugated carbon-carbon double bonds).

The expression “synthetic diene elastomer capable of being used in the compositions in accordance with the invention” is understood in particular to mean:
(a)-any homopolymer of a conjugated or non-conjugated diene monomer other than natural rubber;
(b)-any copolymer of a conjugated or non-conjugated diene and of at least one other monomer.

The expression “copolymer of a conjugated or non-conjugated diene and of at least one other monomer” should be understood as meaning a copolymer of a diene and of one or more other monomer(s). Mention may be made, as other monomer, of ethylene, an olefin and a conjugated or non-conjugated diene other than the first diene.

Suitable conjugated dienes include conjugated dienes having from 4 to 24 carbon atoms, in particular 1,3-dienes having 4 to 12 carbon atoms, and more particularly 1,3-butadiene and isoprene.

Suitable olefins include vinylaromatic compounds having from 8 to 20 carbon atoms and aliphatic α-monoolefins having from 3 to 12 carbon atoms. The term “aliphatic α-monoolefin” is understood to mean an aliphatic α-olefin containing just one double bond. Suitable vinylaromatic compounds include, for example, styrene, ortho-, meta- or para-methylstyrene, the “vinyltoluene” commercial mixture or para-(tert-butyl) styrene. Suitable aliphatic α-monoolefins include in particular acyclic aliphatic α-monoolefins having from 3 to 18 carbon atoms.

More particularly, the synthetic diene elastomer useful for the purposes of the invention is:
(a′)-any homopolymer of a conjugated diene monomer other than natural rubber, in particular any homopolymer obtained by polymerization of a conjugated diene monomer having from 4 to 12 carbon atoms;
(b′)-any copolymer obtained by copolymerization of one or more conjugated dienes with one another or with one or more vinylaromatic compounds having from 8 to 20 carbon atoms.

The synthetic diene elastomers useful for the purposes of the invention are preferentially selected from the group consisting of polybutadienes, synthetic polyisoprenes, butadiene copolymers and isoprene copolymers.

The synthetic diene elastomers useful for the purposes of the invention may contain an oil referred to as an “extender oil”, which is generally introduced at the end of the elastomer synthesis process, and are then denoted by the name oil-extended elastomers. In a known manner, the elastomers generally contain antioxidants, usually introduced at the end of the elastomer synthesis process.

Preferably, the content of natural rubber in the rubber composition is greater than 50 parts by weight per hundred parts of the elastomer matrix, or phr, and less than 90 phr, and the content of the synthetic diene elastomer in the rubber composition is greater than 10 phr and less than 50 phr.

According to any one of the embodiments of the invention, the synthetic diene elastomer is preferentially an SBR. Suitable SBRs may include any SBR containing from 1% to 40% by weight of styrene, in particular from 15% to 35% by weight of styrene. The synthetic diene elastomer is more preferentially a solution SBR (SSBR). Preferably, the total content of natural rubber and of SBR is equal to 100 phr; in other words, the elastomers of the elastomer matrix are preferentially natural rubber and an SBR.

The modifying agent is typically a 1,3-dipolar compound containing a nitrile oxide dipole and an N-substituted imidazole function.

The N-substituted imidazole function is preferentially of formula (I) in which the symbol Z₁ represents a hydrogen atom or an alkyl having 1 to 6 carbon atoms, and the symbol Z₂ denotes an attachment to the nitrile oxide dipole. The expression “attachment to the nitrile oxide dipole” is understood to mean a bond or a group which makes it possible to covalently connect the 5-membered ring of the imidazole function to the dipole.

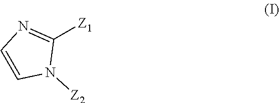

The alkyl represented by Z₁ preferentially contains 1 to 3 carbon atoms, and more preferentially is methyl.

The modifying agent is preferably an aromatic nitrile oxide, a compound comprising an aromatic group substituted by a nitrile oxide dipole and by a group containing the N-substituted imidazole function.

Advantageously, the modifying agent is a compound containing a unit of formula (II) in which R′₁ represents the nitrile oxide dipole, one of the symbols R′₂ to R′₆ represents a saturated group having 1 to 6 carbon atoms which is covalently bonded to one of the nitrogen atoms of the 5-membered ring of the N-substituted imidazole function, the other symbols, which may be identical or different, representing a hydrogen atom or a substituent.

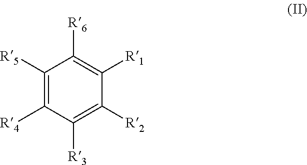

The substituent in formula (II) can be any group as long as it does not react with the dipole. The substituent in formula (II) can form a ring with the substituent of the neighbouring carbon. Preferably, the substituent in formula (II) is an alkyl having 1 to 3 carbon atoms, preferentially methyl or ethyl, more preferentially methyl.

The saturated group in formula (II) makes it possible to covalently bond the imidazole function to the benzene ring substituted in particular by the nitrile oxide dipole. It may contain one or more heteroatoms. It preferentially contains 1 to 3 carbon atoms. The saturated group in formula (II) is preferably an alkanediyl, more preferentially an alkanediyl having 1 to 3 carbon atoms, even more preferentially a methanediyl.

In formula (II), R′₂ and R′₆ are preferentially different from a hydrogen atom. Preferably, R′₂, R′₄ and R′₆ are all different from a hydrogen atom and are identical. R′₂, R′₄ and R′₆ are more preferentially alkyls having 1 to 3 carbon atoms, and even more preferentially methyls.

In formula (II), R′₃ and R's are preferentially each a hydrogen atom.

The synthesis of the 1,3-dipolar compound can be carried out using a relatively easy synthesis route using a commercially available precursor, for example mesitylene, as is described in particular in document WO 2015059269.

Advantageously, the 1,3-dipolar compound is the compound 2,4,6-trimethyl-3-((2-methyl-1H-imidazol-1-yl)methyl)benzonitrile oxide of formula (III) or the compound 2,4,6-triethyl-3-((2-methyl-1H-imidazol-1-yl)methyl)benzonitrile oxide of formula (IV), more advantageously the compound of formula (III).

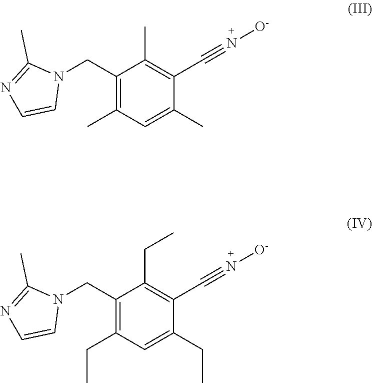

The silica used may be any reinforcing silica known to those skilled in the art, in particular any precipitated or fumed silica having a BET specific surface area and also a CTAB specific surface area both of less than 450 m²/g, preferably in a range extending from 30 to 400 m²/g, in particular from 60 to 300 m²/g. In the present disclosure, the BET specific surface area is determined by gas adsorption using the Brunauer-Emmett-Teller method described in “The Journal of the American Chemical Society”, (vol. 60, page 309, February 1938), and more specifically according to a method derived from the standard NF ISO 5794-1, appendix E, of June 2010 [multipoint (5 point) volumetric method-gas: nitrogen-degassing under vacuum: one hour at 160° C.—relative pressure p/po range: 0.05 to 0.17]. The CTAB specific surface area values were determined according to the standard NF ISO 5794-1, appendix G of June 2010. The process is based on the adsorption of CTAB (N-hexadecyl-N, N, N-trimethylammonium bromide) on the “outer” surface of the reinforcing filler.

Use may be made of any type of precipitated silica, in particular highly dispersible precipitated silicas (HDS, for “highly dispersible silicas”). These precipitated silicas, which may or may not be highly dispersible, are well known to those skilled in the art. Mention may be made, for example, of the silicas described in applications WO 03/016215-A1 and WO 03/016387-A1. Among the commercial HDS silicas, use may in particular be made of the Ultrasil® 5000GR and Ultrasil® 7000GR silicas from Evonik or the Zeosil® 1085GR, Zeosil® 1115 MP, Zeosil® 1165MP, Zeosil® Premium 200MP and Zeosil® HRS 1200 MP silicas from Solvay. Use may be made, as non-HDS silica, of the following commercial silicas: the Ultrasil® VN2GR and Ultrasil® VN3GR silicas from Evonik, the Zeosil® 175GR silica from Solvay or the Hi-Sil EZ120G (-D), Hi-Sil EZ160G (-D), Hi-Sil EZ200G (-D), Hi-Sil 243LD, Hi-Sil 210 and Hi-Sil HDP 320G silicas from PPG.

The reinforcing filler may comprise any type of “reinforcing” filler other than silica, known for its capacity to reinforce a rubber composition which can be used in particular for the manufacture of tires, for example a carbon black. Suitable as carbon blacks are all carbon blacks, in particular the blacks conventionally used in tires or their treads. Among said carbon blacks, mention will more particularly be made of the reinforcing carbon blacks of the 100, 200 and 300 series, or the blacks of the 500, 600 or 700 series (ASTM D-1765-2017 grades), such as, for example, the N115, N134, N234, N326, N330, N339, N347, N375, N550, N683 and N772 blacks. These carbon blacks can be used in the isolated state, as available commercially, or in any other form, for example as support for some of the rubber additives used. When carbon black is used in the rubber composition, it is preferably used in a content of less than or equal to 10 phr (for example, the carbon black content may be within a range extending from 1 to 10 phr). Advantageously, the carbon black content in the rubber composition is less than or equal to 5 phr. Within the intervals indicated, benefit is derived from the colouring properties (black pigmenting agent) and UV-stabilizing properties of the carbon blacks, without, moreover, adversely affecting the typical performance qualities contributed by the silica.

The silica represents more than 50% by mass of the reinforcing filler. In other words, the proportion of silica in the reinforcing filler is greater than 50% by weight of the total weight of the reinforcing filler. Preferentially, the silica represents more than 85% by mass of the reinforcing filler.

The total content of reinforcing filler may vary over a wide range, for example from 30 phr to 150 phr. According to a first embodiment, the total content of reinforcing filler varies within a range extending from 30 phr to 60 phr. According to a second embodiment, the total content of reinforcing filler varies within a range extending from more than 60 phr to 150 phr. The first embodiment is preferred to the second embodiment for use of the rubber composition in a tread having a very low rolling resistance. Any one of these ranges of total content of reinforcing filler can apply to any one of the embodiments of the invention.

To couple the silica to the functional highly saturated diene elastomer, it is well known to use a coupling agent (or bonding agent), a silane, which is at least bifunctional, to ensure a sufficient connection, of a chemical and/or physical nature, between the silica and the diene elastomer. Use is made in particular of organosilanes or polyorganosiloxanes which are at least bifunctional. The term “bifunctional” is understood to mean a compound having a first functional group capable of interacting with the inorganic filler and a second functional group capable of interacting with the diene elastomer. For example, such a bifunctional compound may comprise a first functional group comprising a silicon atom, said first functional group being capable of interacting with the hydroxyl groups of an inorganic filler, and a second functional group comprising a sulfur atom, said second functional group being capable of interacting with the diene elastomer.

Preferentially, the organosilanes are selected from the group consisting of organosilane polysulfides (which may be symmetrical or asymmetrical) such as bis(3-triethoxysilylpropyl) tetrasulfide, abbreviated to TESPT, sold under the name Si69 by Evonik, or bis(triethoxysilylpropyl) disulfide, abbreviated to TESPD, sold under the name Si75 by Evonik, polyorganosiloxanes, mercaptosilanes, blocked mercaptosilanes, such as S-(3-(triethoxysilyl) propyl) octanethioate sold by Momentive under the name NXT Silane, and oligomers having at least one blocked mercaptosilane unit, at least one mercaptosilane unit and at least one cyclic dialkoxysilyl or hydroxyalkoxysilyl group, sold by Momentive under the name NXT-Z. Of course, use might also be made of mixtures of the coupling agents described above.

Silane polysulfides, referred to as “symmetrical” or “asymmetrical” depending on their specific structure, are described, for example, in applications WO 03/002648 (or US 2005/016651) and WO 03/002649 (or US 2005/016650). Particularly suitable, without the definition below being limiting, are silane polysulfides corresponding to the general formula (V)

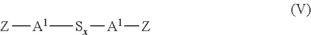

in which:
x is an integer from 2 to 8, preferably from 2 to 5;
the symbols A1, which may be identical or different, represent a divalent hydrocarbon-based radical (preferably a C₁-C₁₈ alkylene group or a C₆-C₁₂ arylene group, more particularly a C₁-C₁₀, especially
C₁-C₄, alkylene, in particular propylene);
the symbols Z, which may be identical or different, correspond to one of the three formulae below:

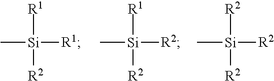

in which:
the radicals R¹, which may be substituted or unsubstituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, in particular C₁-C₄ alkyl groups, more particularly methyl and/or ethyl),
the radicals R², which may be substituted or unsubstituted and identical to or different from one another, represent a C₁-C₁₈ alkoxyl or C₅-C₁₈ cycloalkoxyl group (preferably a group selected from C₁-C₈ alkoxyls and C₅-C₈ cycloalkoxyls, more preferentially still a group selected from C₁-C₄ alkoxyls, in particular methoxyl and ethoxyl).

The Cₙ-Cₘ denomination of a group refers to the number of carbon atoms making up the group, which contains n to m carbon atoms, n and m being integers with m greater than n.

In the case of a mixture of alkoxysilane polysulfides corresponding to the above formula (6), in particular customary commercially available mixtures, the mean value of the “x” indices is a fractional number preferably of between 2 and 5, more preferably of close to 4. However, the invention can also be advantageously implemented, for example, with alkoxysilane disulfides (x=2).

Mention will more particularly be made, as examples of silane polysulfides, of bis((C₁-C₄)alkoxyl(C₁-C₄)alkylsilyl(C₁-C₄)alkyl) polysulfides (in particular disulfides, trisulfides or tetrasulfides), such as, for example, bis(3-trimethoxysilylpropyl) or bis(3-triethoxysilylpropyl) polysulfides. Use is made in particular, among these compounds, of bis(3-triethoxysilylpropyl) tetrasulfide, abbreviated to TESPT, of formula [(C₂H₅O)₃Si(CH₂)₃S₂]₂, or bis(triethoxysilylpropyl) disulfide, abbreviated to TESPD, of formula [(C₂H₅O)₃Si(CH₂)₃S]₂.

Bifunctional POSS (polyorganosiloxanes) or hydroxysilane polysulfides are described for example in the patent applications WO 02/30939 (or U.S. Pat. No. 6,774,255), and WO 02/31041 (or US 2004/051210). Blocked or non-blocked mercaptosilanes are described for example in the patents or patent applications U.S. Pat. No. 6,849,754, WO 99/09036, WO 2006/023815, WO 2007/098080, WO 2010/072685 and WO 2008/055986.

In the rubber composition in accordance with the invention, the content of silane coupling agent is adjusted by a person skilled in the art according to the chemical structure of the coupling agent, according to the specific surface area of the silica used in the rubber composition and according to the silica content in the rubber composition. It is preferentially within a range extending from 1 to 15 phr, more preferentially from 1.5 to 10 phr, even more preferentially from 2 to 8 phr.

Another essential feature of the rubber composition in accordance with the invention is that of containing a vulcanization system, that is to say a sulfur-based crosslinking system. The sulfur is typically provided in the form of molecular sulfur or of a sulfur-donating agent, preferably in molecular form. Sulfur in molecular form is also referred to under the name molecular sulfur. The term “sulfur donor” is understood to mean any compound which releases sulfur atoms, combined or not combined in the form of a polysulfide chain, which are capable of being inserted into the polysulfide chains formed during the vulcanization and bridging the elastomer chains. Various known secondary vulcanization accelerators or vulcanization activators, such as zinc oxide, stearic acid, guanidine derivatives (in particular diphenylguanidine), and the like, are added to the vulcanization system, being incorporated during the first non-productive phase and/or during the productive phase. The sulfur content is preferably between 0.5 and 4 phr and the content of the primary accelerator is preferably between 0.5 and 5 phr. These preferential contents can apply to any one of the embodiments of the invention.

Use may be made, as (primary or secondary) vulcanization accelerator, of any compound that is capable of acting as accelerator of the vulcanization of the diene elastomers in the presence of sulfur, in particular accelerators of the thiazole type and also derivatives thereof, accelerators of sulfenamide type as regards the primary accelerators, or accelerators of thiuram, dithiocarbamate, dithiophosphate, thiourea and xanthate type as regards the secondary accelerators. Mention may in particular be made, as examples of primary accelerators, of sulfenamide compounds, such as N-cyclohexyl-2-benzothiazolesulfenamide (“CBS”), N,N-dicyclohexyl-2-benzothiazolesulfenamide (“DCBS”), N-tert-butyl-2-benzothiazolesulfenamide (“TBBS”) and the mixtures of these compounds.

The primary accelerator is preferentially a sulfenamide, more preferentially N-cyclohexyl-2-benzothiazolesulfenamide. Mention may in particular be made, as examples of secondary accelerators, of thiuram disulfides, such as tetraethylthiuram disulfide, tetrabutylthiuram disulfide (“TBTD”), tetrabenzylthiuram disulfide (“TBZTD”) and the mixtures of these compounds. The secondary accelerator is preferentially a thiuram disulfide, more preferentially tetrabenzylthiuram disulfide.

The vulcanization is performed in a known manner at a temperature generally of between 130° C. and 200° C., for a sufficient time which may range, for example, between 5 and 90 min, as a function especially of the curing temperature, of the vulcanization system adopted and of the vulcanization kinetics of the composition under consideration.

The rubber composition in accordance with the invention may also comprise all or some of the usual additives customarily used in elastomer compositions intended for the manufacture of tires, in particular pigments, protective agents such as anti-ozone waxes, chemical anti-ozonants, antioxidants, and plasticizers such as plasticizing oils or resins. These additives are generally incorporated into the rubber composition before step b) of the process in accordance with the invention, for example during step a).

The rubber composition is typically manufactured in appropriate mixers, using two successive phases of preparation according to a procedure well known to those skilled in the art: a phase of thermomechanical working or kneading (sometimes referred to as a “non-productive” phase) at high temperature, up to a maximum temperature of between 110° C. and 190° C., preferably between 130° C. and 180° C., followed by a phase of mechanical working (sometimes referred to as a “productive” phase) at lower temperature, typically below 110° C., for example between 40° C. and 100° C., during which finishing phase the sulfur or the sulfur donor and the vulcanization accelerator are incorporated.

By way of example, the non-productive phase is conducted in a single thermomechanical step during which all the necessary ingredients, the optional supplementary processing aids and various other additives, with the exception of the vulcanization system, are introduced into an appropriate mixer, such as a customary internal mixer. The total duration of the kneading, in this non-productive phase, is preferably between 1 and 15 min. After cooling the mixture thus obtained during the non-productive phase, the vulcanization system is then incorporated at low temperature, generally in an external mixer, such as an open mill; everything is then mixed (productive phase) for a few minutes, for example between 2 and 15 min.

According to the invention, a step of thermomechanically kneading the elastomer matrix alone is carried out before proceeding with step a). Thermomechanically kneading the elastomer matrix alone prior to step a) means that the elastomers of the elastomer matrix are kneaded together before step a). Preferably, the thermomechanical kneading of the elastomer matrix alone is carried out until a maximum temperature of between 80° C. and 160° C., preferentially ranging from 110° C. to 130° C., is reached. The thermomechanical kneading of the elastomer matrix alone typically takes place in a customary internal mixer that may also be used for proceeding with step a).

The modifying agent is added to the elastomer matrix in order to be incorporated therein and to react with the elastomer matrix by a grafting reaction according to a [3+2] cycloaddition of the dipole onto the diene units of the elastomer matrix. Preferably, in step a) the modifying agent is incorporated into the elastomer matrix before the other ingredients of the rubber composition.

According to a first variant, the modifying agent is incorporated by thermomechanical kneading in a customary internal mixer which may be that used for the prior kneading of the elastomer matrix. The thermomechanical kneading is carried out until a preferential maximum temperature of between 80° C. and 160° C., preferentially ranging from 110° C. to 130° C., is reached, in order to enable both the incorporation of the modifying agent into the elastomer matrix and the grafting of all or some of the modifying agent onto the elastomer matrix, for example 60% to 80% of the amount of the modifying agent added. The contact time between the elastomer matrix and the modifying agent during the thermomechanical kneading is adjusted as a function of the conditions of the thermomechanical kneading, in particular as a function of the temperature. The higher the temperature of the kneading, the shorter this contact time. Typically, it is from 1 to 5 minutes for a temperature of from 110° C. to 130° C. The thermomechanical kneading in the internal mixer may be followed by kneading on an external mixer for example in order to perform sampling intended to characterize the product resulting from the thermomechanical kneading of the elastomer matrix and the modifying agent. In order to carry out the kneading on an external mixer with complete safety, a step of cooling the product taken from the internal mixer is generally performed in order to avoid burns when handling it.

According to a second variant, the modifying agent is incorporated on an external mixer, such as an open mill, at a temperature of less than 60° C., followed by heat treatment, for example under a press or in an oven, at temperatures ranging from 80° C. to 200° C., in order to graft the modifying agent onto the elastomer matrix.

According to a third variant, the modifying agent is incorporated on an external mixer, such as an open mill, at a temperature of greater than 60° C., this not requiring additional heat treatment in order to graft the modifying agent onto the elastomer matrix.

The amount of modifying agent added in step a) may vary within a range of between 0 and 3 mol % of the monomer units of the elastomer matrix. This amount is adjusted by those skilled in the art according to the amount of silica in the rubber composition and according to the use of the rubber composition. The lower the hysteresis sought for the rubber composition, the greater the amount of the modifying agent. The amount of modifying agent added in step a) is lower preferentially than 2 mol %, more preferentially than 1 mol %, and even more preferentially than 0.5 mol % of the monomer units of the elastomer matrix. It is greater preferentially than 0.02 mol % and more preferentially than 0.05 mol % of the monomer units of the elastomer matrix. The lowest contents of modifying agent are generally associated with low contents of silica.

The rubber composition can be calendered or extruded in the form of a sheet or of a slab, in particular for a laboratory characterization, or also in the form of a rubber semi-finished product (or profiled element) which can be used in a tire. The composition may be either in the green state (before crosslinking or vulcanization), or in the cured state (after crosslinking or after vulcanization). It may constitute all or some of a semi-finished article, in particular intended for use in a pneumatic or non-pneumatic tire which comprises a tread, in particular in the tread of the tire.

The rubber composition manufactured according to the process in accordance with the invention is advantageously vulcanized, preferably at a temperature of greater than 110° C., in particular after having been extruded or calendered in the form of a semi-finished article such as a tire tread.

In summary, the invention is advantageously implemented according to any one of the following embodiments 1 to 25:
Embodiment 1: Process for preparing a rubber composition which comprises an elastomer matrix, a modifying agent comprising a nitrile oxide dipole and an N-substituted imidazole function, a reinforcing filler comprising more than 50% by mass of a silica, a silane coupling agent and a vulcanization system, which process comprises the following successive steps a, b, c and d:
   a) incorporating, into the elastomer matrix, during a “non-productive” step, the modifying agent, the reinforcing filler and the silane coupling agent, by kneading until a maximum temperature of between 110° C. and 190° C. is reached,
   b) cooling the combined mixture to a temperature of less than 100° C.,
   c) subsequently incorporating the vulcanization system,
   d) kneading everything up to a maximum temperature of less than 120° C., characterized in that the elastomer matrix comprises natural rubber and a synthetic diene elastomer, and in that the process comprises a step of thermomechanically kneading the elastomer matrix alone prior to step a).
Embodiment 2: Process according to Embodiment 1, wherein the thermomechanical kneading of the elastomer matrix alone is carried out until a maximum temperature of between 80° C. and 160° C. is reached.
Embodiment 3: Process according to Embodiment 1 or 2, wherein the thermomechanical kneading of the elastomer matrix alone is carried out until a maximum temperature ranging from 110° C. to 130° C. is reached.
Embodiment 4: Process according to any one of Embodiments 1 to 3, wherein the modifying agent is incorporated into the elastomer matrix before the other ingredients of the rubber composition.
Embodiment 5: Process according to Embodiment 4, wherein the modifying agent is incorporated into the elastomer matrix alone by thermomechanical kneading in an internal mixer until a maximum temperature of between 80° C. and 160° C., preferentially ranging from 110° C. to 130° C., is reached.
Embodiment 6: Process according to Embodiment 4, wherein the modifying agent is incorporated in an external mixer at a temperature of less than 60° C. followed by a heat treatment at temperatures ranging from 80° C. to 200° C.
Embodiment 7: Process according to Embodiment 4, wherein the modifying agent is incorporated in an external mixer at a temperature of greater than 60° C.
Embodiment 8: Process according to any one of Embodiments 1 to 7, wherein the content of natural rubber in the rubber composition is greater than 50 parts by weight per hundred parts of the elastomer matrix, or phr, and less than 90 phr, and the content of the synthetic diene elastomer in the rubber composition is greater than 10 phr and less than 50 phr.
Embodiment 9: Process according to any one of Embodiments 1 to 8, wherein the synthetic diene elastomer is an SBR.
Embodiment 10: Process according to any one of Embodiments 1 to 9, wherein the synthetic diene elastomer is a solution SBR.
Embodiment 11: Process according to any one of Embodiments 1 to 10, wherein the synthetic diene elastomer is an SBR containing 1% to 40% by weight of styrene.
Embodiment 12: Process according to any one of Embodiments 1 to 11, wherein the synthetic diene elastomer is an SBR containing 15% to 35% by weight of styrene.
Embodiment 13: Process according to any one of Embodiments 1 to 12, wherein the amount of modifying agent added in step a) varies within a range of between 0 and 3 mol % of the monomer units of the elastomer matrix.
Embodiment 14: Process according to any one of Embodiments 1 to 13, wherein the silica represents more than 85% by mass of the reinforcing filler.
Embodiment 15: Process according to any one of Embodiments 1 to 14, wherein the N-substituted imidazole function is of formula (I) in which the symbol Z₁ represents a hydrogen atom or an alkyl having 1 to 6 carbon atoms, and the symbol Z₂ denotes an attachment to the nitrile oxide dipole.

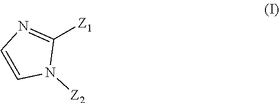

Embodiment 16: Process according to Embodiment 15, wherein the alkyl represented by Z₁ contains 1 to 3 carbon atoms.
Embodiment 17: Process according to Embodiment 15 or 16, wherein the alkyl represented by Z₁ is methyl.
Embodiment 18: Process according to any one of Embodiments 1 to 17, wherein the modifying agent is an aromatic nitrile oxide, a compound comprising an aromatic group substituted by a nitrile oxide dipole and by a group containing the N-substituted imidazole function.
Embodiment 19: Process according to any one of Embodiments 1 to 18, wherein the modifying agent is a compound containing a unit of formula (II) in which R′₁ represents the nitrile oxide dipole, one of the symbols R′₂ to R's represents a saturated group having 1 to 6 carbon atoms which is covalently bonded to one of the nitrogen atoms of the 5-membered ring of the N-substituted imidazole function, the other symbols, which may be identical or different, representing a hydrogen atom or a substituent.

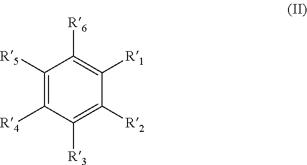

Embodiment 20: Process according to Embodiment 19, wherein the saturated group is an alkanediyl.
Embodiment 21: Process according to Embodiment 19 or 20, wherein the saturated group is an alkanediyl having 1 to 3 carbon atoms.
Embodiment 22: Process according to any one of Embodiments 19 to 21, wherein the saturated group is a methanediyl.
Embodiment 23: Process according to any one of Embodiments 19 to 22, wherein R′₂, R′₄ and R′₆ are each an alkyl.
Embodiment 24: Process according to any one of Embodiments 19 to 23, wherein R′₂, R′₄ and R′₆ are each methyl or ethyl.
Embodiment 25: Process according to any one of Embodiments 19 to 24, wherein R′₃ and R′5 are each a hydrogen atom.

The abovementioned features of the present invention, and also others, will be better understood on reading the following description of several exemplary embodiments of the invention, which are given by way of nonlimiting illustration.

### EXAMPLES

### Dynamic Properties

The dynamic properties tanδ (max) are measured on a viscosity analyser (Metravib VA4000) according to the standard ASTM D 5992-96. The response of a sample of vulcanized composition (cylindrical test specimen with a thickness of 4 mm and a cross section of 400 mm²), subjected to a simple alternating sinusoidal shear stress, at a frequency of 10 Hz, at 60° C., is recorded. A strain amplitude sweep is carried out from 0.1% to 100% (outward cycle) and then from 100% to 0.1% (return cycle). The results made use of are the loss factor tanδ and the difference in modulus (ΔG*) between the values at 0.1% and 100% strain (Payne effect). For the return cycle, the maximum value of tanδ observed, denoted tanδ (max), is indicated. The results are expressed in base 100, with respect to a control. A value greater than that of the control, arbitrarily set at 100, indicates a measured quantity greater than that of the control.

### Tensile Tests:

The tensile tests make it possible to determine the elasticity stresses and the properties at break. Unless otherwise indicated, they are carried out in accordance with the French standard NF T 46-002 of September 1988. Processing the tensile recordings also makes it possible to plot the curve of modulus as a function of the elongation. The modulus used here being the nominal (or apparent) secant modulus measured in first elongation, calculated by normalizing to the initial cross section of the test specimen. The nominal secant moduli (or apparent stresses, in MPa) at 100% elongation, denoted MSA100, are measured in first elongation. The breaking stresses (in MPa) and the elongations at break (in %) are measured at 23° C.±2° C. according to the standard NF T 46-002. The results are expressed in base 100, with respect to a control. A value greater than that of the control, arbitrarily set at 100, indicates an improved result, that is to say a measured quantity greater than that of the control.

### Preparation of the Rubber Compositions:

The formulations (in phr) of the rubber compositions prepared are described in Table 1.

The elastomer matrix is a mixture of 75 phr of natural rubber and 25 phr of an SBR. The SBR is a solution SBR containing 26% styrene units and 56% 1,2-units of the butadiene part.

A 1,3-dipolar compound, 2,4,6-trimethyl-3-((2-methyl-1H-imidazol-1-yl)methyl)benzonitrile oxide, the synthesis of which is described in patent application WO 2015059274, is used as modifying agent.

Preparation of a rubber composition A1 according to a process not in accordance with the invention:

The natural rubber, the SBR, followed by the silica, and then the silane coupling agent are introduced into an internal mixer (final filling level: about 70% by volume), the initial tank temperature of which is about 110° C., and are kneaded for one to two minutes, and then the various other ingredients except for the vulcanization system are added. Thermomechanical working (non-productive phase) is then carried out in one step, which lasts approximately 5 min to 6 minutes, until a maximum “dropping” temperature of 160° C. is reached. The mixture thus obtained is recovered and cooled and then sulfur and an accelerator of sulfenamide type are incorporated on a mixer (homofinisher) at 23° C., everything being mixed (productive phase) for an appropriate time (for example between 5 and 12 min).

Preparation of a rubber composition A2 according to a process not in accordance with the invention:

The process for preparing rubber composition A2 is identical to that of A1 except that thermomechanical kneading of the two elastomers is carried out for 30 seconds before the silica is added.

Preparation of a rubber composition A3 according to a process not in accordance with the invention:

The process for preparing rubber composition A3 is identical to that of A1 except that the natural rubber and the SBR are each modified beforehand with a modifying agent according to the following procedure:

The elastomer to be modified, in the present case the natural rubber or the SBR, and then the modifying agent are introduced into an internal mixer (final filling level: about 70% by volume), the initial tank temperature of which is about 110° C., and are then kneaded for two minutes at 120° C. The resulting product is recovered, cooled and homogenized on an external mixer (open mill) at 30° C. (15 turnover passes).

The amount of modifying agent is 1.13 phr in the case of natural rubber (i.e. 0.3 mol % of the monomer units of the natural rubber); it is 1.24 phr in the case of SBR (i.e. 0.3 mol % of the monomer units of the SBR).

It follows that in the process of A3, the silica and the other ingredients of the rubber composition are incorporated into the elastomer matrix which is constituted of the modified natural rubber and the modified SBR.

Preparation of a rubber composition A4 according to a process not in accordance with the invention:

The process for preparing rubber composition A4 is identical to that of A3 except that only the natural rubber is modified beforehand with the modifying agent (1.13 phr).

Preparation of a rubber composition A5 according to a process not in accordance with the invention:

The process for preparing rubber composition A5 is identical to that of A3 except that only the SBR is modified beforehand with the modifying agent (1.24 phr instead of 1.13 phr, i.e. 0.3 mol %).

Preparation of a rubber composition A6 according to a process in accordance with the invention:

The natural rubber and the SBR are introduced into an internal mixer (final filling level: about 70% by volume), the initial tank temperature of which is about 110° C., and are kneaded for 30 seconds, and then the modifying agent (1.13 phr) is added, kneading is carried out for two minutes at 120° C., and then the silica followed by the silane coupling agent are added, kneading is carried out for one to two minutes, and then the various other ingredients except for the vulcanization system are added. Thermomechanical working (non-productive phase) is then carried out in one step, which lasts approximately 5 min to 6 minutes, until a maximum “dropping” temperature of 160° C. is reached. The mixture thus obtained is recovered and cooled and then sulfur and an accelerator of sulfenamide type are incorporated on an external mixer (homofinisher) at 23° C., everything being mixed (productive phase) for an appropriate time for 5 to 6 minutes.

Preparation of a rubber composition A7 according to a process in accordance with the invention:

The process for preparing rubber composition A7 is identical to that of A6 except that 0.75 phr of the modifying agent are added instead of 1.13 phr.

The process for preparing rubber compositions A6 and A7 differs from that of A2 in that a modifying agent is added to the elastomer matrix in order to be incorporated into the elastomer matrix and be grafted onto the elastomer matrix.

The compositions thus obtained are subsequently calendered, either in the form of slabs (with a thickness ranging from 2 to 3 mm) or thin sheets of rubber, for the measurement of their physical or mechanical properties, or in the form of profiled elements which can be used directly, after cutting and/or assembling to the desired dimensions, for example as semi-finished products for tires, in particular for treads.

The crosslinking is carried out at 150° C.

The results appear in Table 2.

TABLE 1

| Compositions (in phr) | A1 | A2 | A3 | A4 | A5 | A6 | A7 |
|---|---|---|---|---|---|---|---|
| NR (1) | 75 | 75 | | | 75 | 75 | 75 |
| SBR (2) | 25 | 25 | | 25 | | 25 | 25 |
| Modified NR (3) | | | 75 | 75 | | | |
| Modified SBR (4) | | | 25 | | 25 | | |
| Modifying agent (5) | | | | | | 1.13 | 0.75 |
| Silica (6) | 55 | 55 | 55 | 55 | 55 | 55 | 55 |
| Carbon black (7) | 3 | 3 | 3 | 3 | 3 | 3 | 3 |
| Silane coupling | 5.5 | 5.5 | 5.5 | 5.5 | 5.5 | 5.5 | 5.5 |
| agent (8) | | | | | | | |
| DPG (9) | 0.5 | 0.5 | 0.5 | 0.5 | 0.5 | 0.5 | 0.5 |
| Anti-ozone wax (10) | 1 | 1 | 1 | 1 | 1 | 1 | 1 |
| Antioxidant (11) | 1 | 1 | 1 | 1 | 1 | 1 | 1 |
| Antioxidant 6PPD (12) | 1.5 | 1.5 | 1.5 | 1.5 | 1.5 | 1.5 | 1.5 |
| Stearic acid (13) | 2.5 | 2.5 | 2.5 | 2.5 | 2.5 | 2.5 | 2.5 |
| ZnO (14) | 2.7 | 2.7 | 2.7 | 2.7 | 2.7 | 2.7 | 2.7 |
| Sulfur | 1.3 | 1.3 | 1.3 | 1.3 | 1.3 | 1.3 | 1.3 |
| CBS (15) | 1.6 | 1.6 | 1.6 | 1.6 | 1.6 | 1.6 | 1.6 |

(1) Natural rubber
(2) SBR containing 26% by weight of styrene and 56% 1,2-butadiene units
(3) NR modified according to the procedure described in the process for preparing A3
(4) SBR modified according to the procedure described in the process for preparing A3
(5) 2,4,6-Trimethyl-3-((2-methyl-1H-imidazol-1-yl)methyl)benzonitrile oxide
(6) Zeosil 1165 MP from Solvay-Rhodia in the form of micropearls
(7) Carbon black N234
(8) Triethoxysilylpropyl tetrasulfide (TESPT) liquid silane, Si69 from Evonik
(9) Diphenylguanidine, Perkacit DPG from Flexsys
(10) Anti-ozone wax, Varazon 4959 from Sasol Wax
(11) Tetramethylquinone
(12) N-(1,3-Dimethylbutyl)-N′-phenyl-p-phenylenediamine, Santoflex 6PPD from Flexsys
(13) Stearic acid, Pristerene 4931 from Uniqema
(14) Zinc oxide, industrial grade from Umicore
(15) N-Cyclohexyl-2-benzothiazolesulfenamide, Santocure CBS from Flexsys

TABLE 2

| Composition | A1 | A2 | A3 | A4 | A5 | A6 | A7 |
|---|---|---|---|---|---|---|---|
| MSA100 at 60° | 100 | 101 | 127 | 100 | 127 | 154 | 119 |
| tanδ(max) 60° C. | 100 | 106 | 53 | 70 | 65 | 53 | 59 |

The composition A6, in which the elastomers are kneaded together before the introduction of 1.13 phr of modifying agent and the other ingredients, exhibits a stiffness at medium strain (MSA100 at 60° C.) which is higher than composition A3 without, however, increasing the hysteresis as seen via tanδ (max) at 60° C. From the comparison of rubber compositions A3 and A6, it is observed that the process in accordance with the invention that leads to the obtaining of composition A6 achieves an increase in the stiffness in the cured state of the rubber compositions without adversely affecting the hysteresis. This result is achieved even though the amount of modifying agent used is only 1.13 phr in A6 instead of 2.37 phr in A3.

Even compositions A4 and A5, which have been prepared with much lower contents of modifying agent than that of A3, at 1.13 phr and 1.24 phr, respectively, do not exhibit as low a hysteresis or as high a stiffness as those of A6.

A comparison between compositions A1 and A2, which are not in accordance with the invention and which differ from each other by a step of thermomechanically kneading the two elastomers together in the process of A2, shows that it is not the step of thermomechanically kneading the two elastomers together that is alone responsible for the compromise of properties between the hysteresis and the stiffness that is obtained by using the process in accordance with the invention.

It is also observed that composition A7, prepared according to the process in accordance with the invention and with a content of modifying agent of just 0.75 phr, also exhibits an advantageous compromise of properties between stiffness and hysteresis in comparison to compositions A4 and A5 that were however prepared with a higher content of modifying agent, at 1.13 phr and 1.24 phr, respectively.

The process in accordance with the invention proves to be the most effective process for obtaining the best compromise between the properties of hysteresis, stiffness and amount of modifying agent.

What is claimed is:

1. A process for preparing a rubber composition which comprises an elastomer matrix, a modifying agent comprising a nitrile oxide dipole and an N-substituted imidazole function, a reinforcing filler comprising more than 50% by mass of a silica, a silane coupling agent and a vulcanization system, which process comprises the following successive steps a, b, c and d:
a) incorporating, into the elastomer matrix, during a “non-productive” step, the modifying agent, the reinforcing filler and the silane coupling agent, by kneading until a maximum temperature of between 11° and 190° C. is reached,
b) cooling the combined mixture to a temperature of less than 100° C.,
c) subsequently incorporating the vulcanization system,
d) kneading everything up to a maximum temperature of less than 120° C., wherein the elastomer matrix comprises natural rubber and a synthetic diene elastomer, and the process comprises a step of thermomechanically kneading the elastomer matrix alone prior to step a).

2. The process according to claim 1, wherein the thermomechanical kneading of the elastomer matrix alone is carried out until a maximum temperature of between 80° C. and 160° C. is reached.

3. The process according to claim 1, wherein in step a) the modifying agent is incorporated into the elastomer matrix before the other ingredients of the rubber composition.

4. The process according to claim 1, wherein the content of natural rubber in the rubber composition is greater than 50 parts by weight per hundred parts of the elastomer matrix, or phr, and less than 90 phr, and the content of the synthetic diene elastomer in the rubber composition is greater than 10 phr and less than 50 phr.

5. The process according claim 1, wherein the synthetic diene elastomer is an SBR, preferentially a solution SBR.

6. The process according to claim 1, wherein the amount of modifying agent added in step a) varies within a range of between 0 and 3 mol % of the monomer units of the elastomer matrix.

7. The process according to claim 1, wherein the silica represents more than 85% by mass of the reinforcing filler.

8. The process according to claim 1, wherein the N-substituted imidazole function is of formula (I) in which the symbol Z₁ represents a hydrogen atom or an alkyl having 1 to 6 carbon atoms, and the symbol Z₂ denotes an attachment to the nitrile oxide dipole.

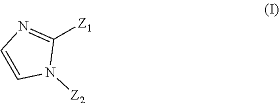

9. The process according to claim 1, wherein the modifying agent is an aromatic nitrile oxide, a compound comprising an aromatic group substituted by a nitrile oxide dipole and by a group containing the N-substituted imidazole function.

10. The process according to claim 1, wherein the modifying agent is a compound containing a unit of formula (II) in which R′₁ represents the nitrile oxide dipole, one of the symbols R′₂ to R′₆ represents a saturated group having 1 to 6 carbon atoms which is covalently bonded to one of the nitrogen atoms of the 5-membered ring of the N-substituted imidazole function, the other symbols, which may be identical or different, representing a hydrogen atom or a substituent.

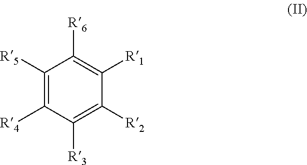

11. The process according to claim 10, wherein the saturated group is an alkanediyl.

12. The process according to claim 10, wherein R′₂, R′₄ and R′₆ are each an alkyl.

13. The process according to claim 10, wherein R′₃ and R's are each a hydrogen atom.

14. The process according to claim 2, wherein the thermomechanical kneading of the elastomer matrix alone is carried out until a maximum temperature of between 110° C. to 130° C. is reached.

15. The process according to claim 5, wherein the SBR is a solution SBR.

16. The process according to claim 11, wherein the alkanediyl has 1 to 3 carbon atoms.

17. The process according to claim 12, wherein the R′₂, R′₄ and R′₆ are each methyl or ethyl.
